(19) United States
(12) Patent Application Publication
(10) Pub. No.: US 2002/0123937 A1
(43) Pub. Date: Sep. 5, 2002

(54) System and method for peer-to-peer commerce

(76) Inventors: Clifford A. Pickover, Yorktown Heights, NY (US); Paul A. Moskowitz, Yorktown Heights, NY (US); William Grey, Millwood, NY (US); Stephen J. Boies, Mahopac, NY (US)

Correspondence Address: BUCKLEY, MASCHOFF, TALWALKAR, & ALLISON, 5 ELM STREET, NEW CANAAN, CT, 06840, US

(21) Appl. No.: 09/797,121

(22) Filed: Mar. 1, 2001

(51) Int. Cl. G06F 17/60

(52) U.S. Cl. 705/26

(57) ABSTRACT

A system, method, apparatus and medium to sell an item includes storage of information representing an item for sale in a peer device of a peer-to-peer network comprising a plurality of peer devices, and exposure of the information to one or more of the plurality of peer devices. As a result, a seller may easily offer an item for sale to many buyers over a robust network without incurring high overhead costs.

### BACKGROUND OF THE INVENTION

1. Field Of The Invention

The present invention relates to systems for selling items. More specifically, the present invention concerns systems for buying and selling items using networked devices.

2. Description Of The Related Art

Sellers use many methods for selling items to buyers. According to one method, a seller establishes a traditional brick-and-mortar store that buyers may visit in order to purchase items sold therein. According to another method, a seller produces and mails catalogs describing items which may be purchased using a mailed-in order form or by calling a phone number listed in the catalog.

The above methods are unsuitable for many would-be sellers. For example, the cost of establishing a store or producing a catalog is often either prohibitive or unjustifiable in view of expected profits. As a result, individual sellers turn to other methods for selling items, such as garage sales or classified advertisements. These latter methods are less costly than the previously described methods, but these methods allow only a few potential buyers to easily locate and purchase items for sale.

In an attempt to address some of the drawbacks of the foregoing conventional methods, sellers are using the World Wide Web (“the Web”) as a means for selling items to buyers. The Web advantageously allows a buyer to search many websites for a particular item, to remotely access a website selling the item, and to purchase the item from the website. As a result, the Web facilitates the sale of items to a vast number of buyers while requiring less capital expenditure than brick-and-mortar stores and catalogs.

Despite the foregoing, the cost and time required to develop and host a website may be prohibitive and/or unjustifiable for many sellers. In addition, the performance of such a website decreases as a number of “hits” received by the website increases or as traffic on the Web increases. Therefore, as Web traffic continues to increase without corresponding increases in bandwidth, Web-based sales systems may prove to be unsuitable.

In view of the foregoing, what is needed is a system, method, apparatus, and computer-readable medium providing for the sale of items that is efficient, inexpensive and robust.

### SUMMARY OF THE INVENTION

In order to address the foregoing needs, the present invention provides a system, method, apparatus and medium to facilitate the purchase of items. According to one aspect of the invention, a peer device storing information representing a desired item is identified from among a plurality of peer devices of a peer-to-peer network storing data representing one or more items for sale, and an indication to purchase the item is transmitted. By virtue of this aspect, a buyer may utilize a peer device to locate a desired item and to purchase the item over a robust network.

In another aspect, the present invention provides a system, method, apparatus and medium to facilitate the sale of items in which information representing an item for sale is stored in a peer device of a peer-to-peer network comprising a plurality of peer devices, and the information is exposed to one or more of the plurality of peer devices. As a result, a seller may easily offer an item for sale to many buyers over a robust network without incurring high overhead costs.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a topographic view of a peer-to-peer network architecture according to embodiments of the present invention.

FIG. 2 is a block diagram of an internal architecture of a peer device according to embodiments to the present invention.

FIG. 3 is a representative view of a tabular portion of a sale item information database according to embodiments of the present invention.

FIG. 4 is a representative view of a tabular portion of a buyer information database according to embodiments of the present invention.

FIG. 5 is a flow diagram of process steps to sell an item according to embodiments of the present invention.

FIG. 6 is a flow diagram of process steps to purchase an item according to embodiments of the present invention.

### DETAILED DESCRIPTION

Network Architecture

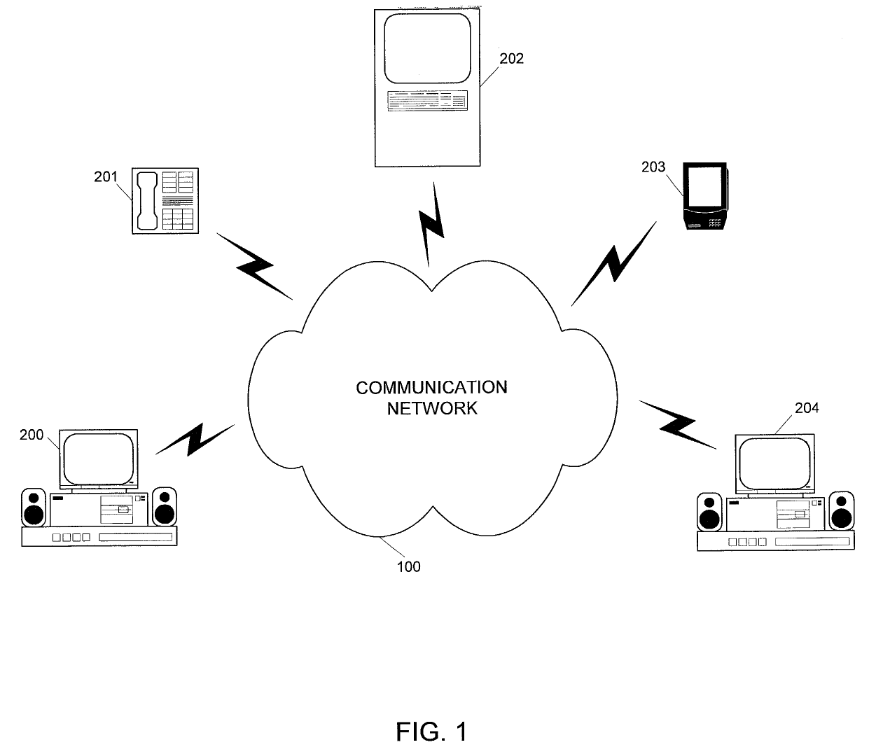

FIG. 1 is a topographic view of a peer-to-peer network architecture according to embodiments of the present invention. Of course, peer-to-peer architectures other that that shown in FIG. 1 may be used to implement the invention. In a peer-to-peer network, each peer device often has similar capabilities and responsibilities. This arrangement differs from client/server network architectures such as the Web, in which some devices are dedicated to serving the others. Some peer-to-peer networks use servers to direct traffic, while others are server-free implementations that directly connect peer devices over a network.

FIG. 1 shows communication network 100 in communication with various peer devices 200 to 204. Communication network 100 may include devices that are not part of a peer-to-peer network. In this regard, the invention may be embodied in a segmented peer-to-peer system including peer devices and devices outside the peer-to-peer network.

In some embodiments, one or more of the FIG. 1 components are in direct communication with one or more of the other components. It should be noted that the devices shown in communication with communication network 100 need not be constantly exchanging data with communication network 100. Rather, communication may be established when necessary and severed at other times or always available but rarely used to transmit data. Moreover, although the illustrated communication links between the components of FIG. 1 and communication network 100 appear dedicated, it should be noted that each of the links may be shared by other components.

Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP).

Peer devices 200 to 204 as depicted in FIG. 1 comprise a workstation, a telephone, a kiosk, a personal digital assistant, and another workstation. Peer devices 200 to 204 are used to store sale item information, to sell items, to identify peer devices storing sale information representing a desired item, and to purchase items. In this regard, a peer device usable in conjunction with the present invention includes any device capable of storing information, receiving information, transmitting information, and presenting information visually and/or aurally. Of course, a peer device should be able to communicate with the device or devices with which it is in communication over whatever type of network media exist between the devices.

Peer devices 200 to 204 may be used to execute process steps according to the present invention. Specifically, each of peer devices 200 to 204 may be operated by a buyer to identify a peer device storing information representing a desired item from among a plurality of peer devices of a peer-to-peer network storing data representing one or more items for sale, and to transmit an indication to purchase the item. In addition, each of peer devices 200 to 204 may be operated by a seller to store information representing an item for sale in a peer device of a peer-to-peer network comprising a plurality of peer devices, and to expose the information to one or more of the plurality of peer devices.

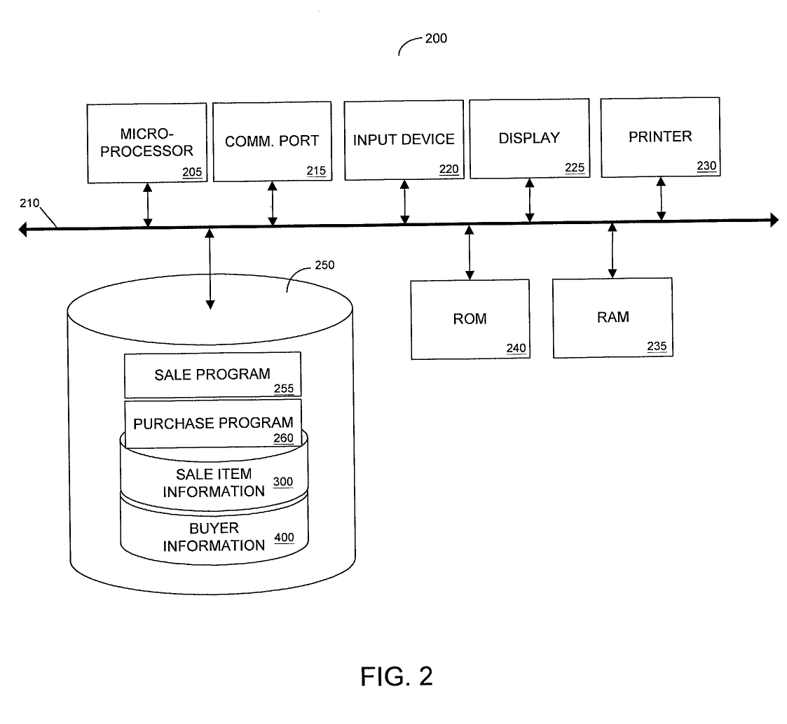

One or more of peer devices 200 to 204 may be operated by an entity such as a private individual, a retail seller, an auction house, and an online auction service. In addition, one or more of peer devices 200 to 204 may be operated by a single entity to sell and/or purchase more than one item. Further details of peer device 200 according to embodiments of the invention are set forth below with respect to FIG. 2.

Peer Device

FIG. 2 is a block diagram of the internal architecture of peer device 200 according to one embodiment of the invention. As illustrated, peer device 200 includes microprocessor 205 in communication with communication bus 210. Microprocessor 205 may be a Pentium™, RlSC™-based, or other type of processor and is used to execute processor-executable process steps so as to control the components of peer device 200 to provide functionality according to embodiments of the present invention.

Also in communication with communication bus 210 is communication port 215. Communication port 215 is used to transmit data to and to receive data from external devices. Communication port 215 is therefore preferably configured with hardware suitable to physically interface with desired external devices and/or network connections. In one embodiment, stored information representing items for sale and indications to purchase items are received from and transmitted to other peer devices over communication port 215.

Input device 220, display 225 and printer 230 are also in communication with communication bus 210. Any known input device may be used as input device 220, including a keyboard, mouse, touch pad, voice-recognition system, or any combination of these devices. Input device 220 may be used by a seller to input information representing items for sale, such as a description and a sale price. Input device 220 may also be used to input search terms used to identify a peer device storing information representing a desired item. Of course, such information may also be input to peer device 200 via communication port 215. Commands for controlling operation of peer device 200 may also be input using input device 220, such as commands to expose information representing an item for sale to other peer devices, to purchase an item from another peer device, and to output a report detailing sales data.

Such a report may be output to display 225, which may be an integral or separate CRT display, flat-panel display or the like. Display 225 is generally used to output graphics and text to an operator in response to commands issued by microprocessor 205. Printer 230 may also output graphics and text, but in hardcopy form using ink-jet, thermal, dot-matrix, laser, or other printing technologies.

RAM 235 is connected to communication bus 210 to provide microprocessor 205 with fast data storage and retrieval. In this regard, processor-executable process steps being executed by microprocessor 205 are typically stored temporarily in RAM 235 and executed therefrom by microprocessor 205. ROM 240, in contrast, provides storage from which data can be retrieved but to which data cannot be stored. Accordingly, ROM 240 is used to store invariant process steps and other data, such as basic input/output instructions and data used during system boot-up or to control communication port 215. It should be noted that one or both of RAM 235 and ROM 240 may communicate directly with microprocessor 205 instead of over communication bus 210.

Data storage device 250 stores, among other data, sale program 255 of processor-executable process steps. Microprocessor 205 executes process steps of sale program 255 in order to control peer device 200 to sell an item in accordance with the present invention. More specifically, the process steps of sale program 255 may be executed by microprocessor 205 to store information representing an item for sale in a peer device of a peer-to-peer network comprising a plurality of peer devices, and to expose the information to one or more of the plurality of peer devices. As a result of these steps, a seller may easily offer an item for sale to many buyers over a robust network without incurring high overhead costs.

Also stored in data storage device 250 are processor-executable process steps of purchase program 260. The process steps of purchase program 260 may be executed in order to cause peer device 200 to identify a peer device storing information representing a desired item from among a plurality of peer devices of a peer-to-peer network storing data representing one or more items for sale, and to transmit an indication to purchase the item. Accordingly, a buyer may utilize peer device 200 to locate a desired item and to purchase the item over a robust network.

The process steps of sale program 255 and purchase program 260 may be read from a computer-readable medium, such as a floppy disk, a CD-ROM, a DVD-ROM, a Zip™ disk, a magnetic tape, or a signal encoding the process steps, and then stored in data storage device 250 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

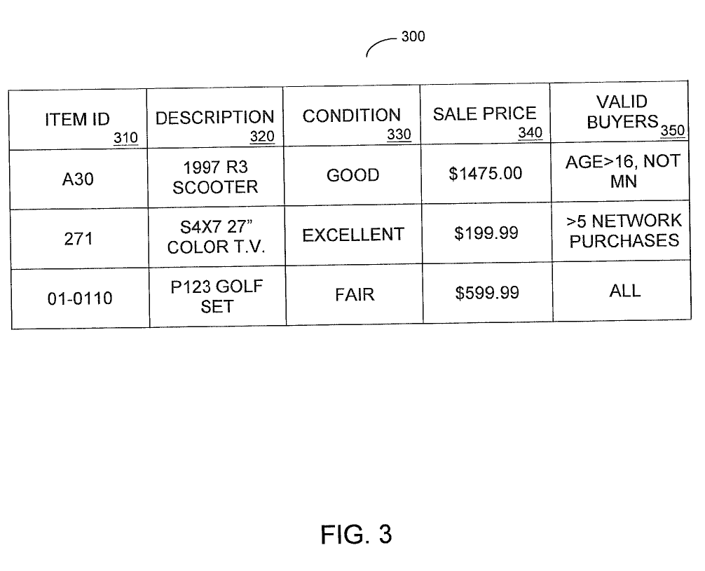

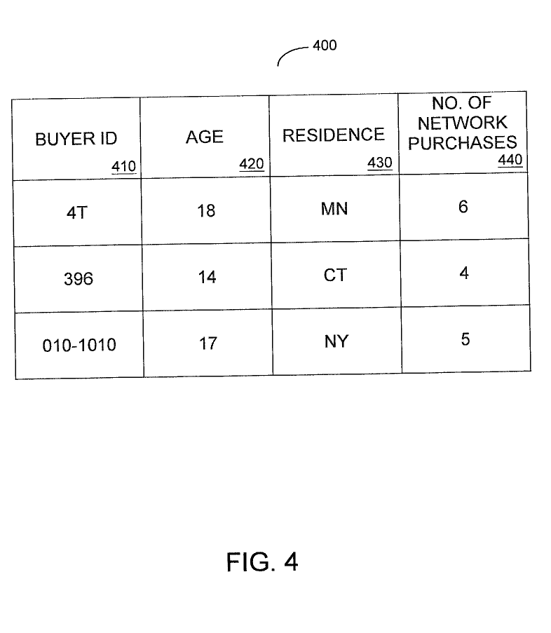

Data storage device 250 also stores sale item information database 300 and buyer information database 400. Sale item information database 300 and buyer information database 400 include information usable in conjunction with sale program 255 and purchase program 260 to sell and to purchase an item in accordance with the present invention. The information stored in sale item information database 300 and buyer information database 400, as well as uses thereof, and its use will be discussed in detail below with reference to FIG. 3 and FIG. 4, respectively.

Stored in data storage device 250 may also be other unshown elements that may be necessary for operation of peer device 200, such as other applications, other data files, an operating system, a database management system and “device drivers” for allowing microprocessor 205 to interface with devices in communication with communication port 215. For example, data storage device 250 may include process steps of an interactive voice response system enabling peer device 200 to receive inquiries from and to transmit information representing an item for sale to telephone peer device 201. These elements are known to those skilled in the art, and are therefore not described in detail herein.

Sale Item Information Database

A tabular representation of a portion of sale item information database 300 is shown in FIG. 3. The information stored in sale information database 300 is used to sell an item to a buyer and to determine those buyers to whom an item may be sold.

As shown, sale item information database 300 includes several records and associated fields. The fields specify, for each item represented in database 300, item ID 310, description 320, condition 330, sale price 340 and valid buyers 350. Item ID 310 identifies an item offered for sale by an entity operating peer device 200. In one embodiment, each peer device stores information representing distinct items. That is, no two peer devices store information representing a same physical instance of an item. Of course, in other embodiments, more than one peer device may store information representing a same physical instance of an item.

Description 320 associated with item ID 310 includes a description of the item represented thereby. Description 320 may include descriptive information other than that shown in FIG. 3, such as a link to a photograph of the item. Condition 330 indicates a condition of the item and is therefore useful in a case that the item is a used item.

Sale price 340 specifies a price for which the associated item is offered. In a case that the item is to be sold via an auction, sale item information database 300 may specify a starting bid price, a minimum bid increment and other auction parameters instead of sale price 340. In this regard, many types of auctions may be used in conjunction with the present invention, including an English auction, a Dutch auction, a single-sided auction, a double-sided auction, a single-quantity auction, a multiple-quantity auction, a first price auction, a Vickerey auction, a multi-attribute auction, a sell-side auction, and a buy-side auction.

Valid buyers 350 specify membership sets to which a buyer must belong in order to purchase the associated item. Alternatively, a buyer may be required to be a member of a subset of the membership sets specified in valid buyers 350 in order to purchase the item. As shown, membership sets listed under valid buyers 350 may be based on demographic information, transaction history, and other information. Moreover, valid buyers 350 may specify a set to which a buyer must not belong in order to purchase an associated item. Taking the first record of FIG. 3 as an example, the item associated with item ID 310 “A30” will not be sold to any buyer from Minnesota. According to yet another embodiment, valid buyers 350 may specify that an item will be sold only to those buyers belonging to a same set as the seller.

It is contemplated that sale item information database 300 may include many more records than those shown and that each record may include fields other than those illustrated in FIG. 3. For example, also included may be fields specifying availability, terms and conditions, delivery details or the like. In addition, the set memberships specified in valid buyers 350 may be based on ratings, payment, or other criteria.

In the illustrated portion of sale item information database 300, each record contains information associated with items being sold in a single marketplace. For example, the records shown in FIG. 3 represent items currently being sold by a single seller. However, sale item information database 300 may also store information representing items being sold by several sellers. Moreover, some items represented in sale item information database 300 may be sold by one seller, with other represented items being sold by one or more other sellers.

Buyer Information Database

FIG. 4 shows a tabular representation of a portion of buyer information database 400 according to embodiments of the invention. The data stored in buyer information database 400 may be evaluated in order to determine whether to sell an item to a particular buyer.

Each record in the illustrated portion of buyer information database 300 includes fields specifying buyer ID 410, age 420, residence 430 and number of network purchases 440. Buyer ID 410 identifies a buyer who may operate a peer device to purchase an item according to the invention, age 420 specifies the buyer's age, and residence 430 indicates the buyer's state of residence. Number of network purchases 440 is a value reflecting a number of purchases made by the buyer using the peer-to-peer network of which device 200 is a peer device.

It should be noted that the fields shown in FIG. 4 include information usable to evaluate whether a buyer is a valid buyer of the items represented in sale item information database 300 of FIG. 3. Buyer information database 400 may include other buyer-specific information in a case that other information is needed to determine whether a potential buyer of an item satisfies the criteria of valid buyers 350 associated with the item. Of course, buyer information database 400 may include other information that is used for other reasons.

Specifically, also included in buyer information database 400 may be a rating indicating a buyer's trustworthiness, ability to pay or other quality. In some embodiments, a buyer may increase his rating by paying a fee and/or by remitting a timely payment each time the buyer purchases an item according to the invention. A rating may also be based on votes cast by buyers belonging to a same or different membership set, or on information provided by a third party such as a credit reporting agency.

Other information which may be stored in buyer information database 400 includes information reflecting a buyer's contribution to the peer-to-peer network and information reflecting a buyer's usage of the network. In this regard, a buyer's access to the network may be limited if the buyer's usage of the network outweighs the buyer's contribution to the network by a predetermined amount.

The tabular illustrations and accompanying descriptions of sale item information database 300 and buyer information database 400 merely represent relationships between stored information. A number of other arrangements may be employed besides those suggested by the tables shown. Similarly, the illustrated entries of the databases represent sample information only; those skilled in the art will understand that the number and content of the entries can be different from those illustrated.

Specific Examples

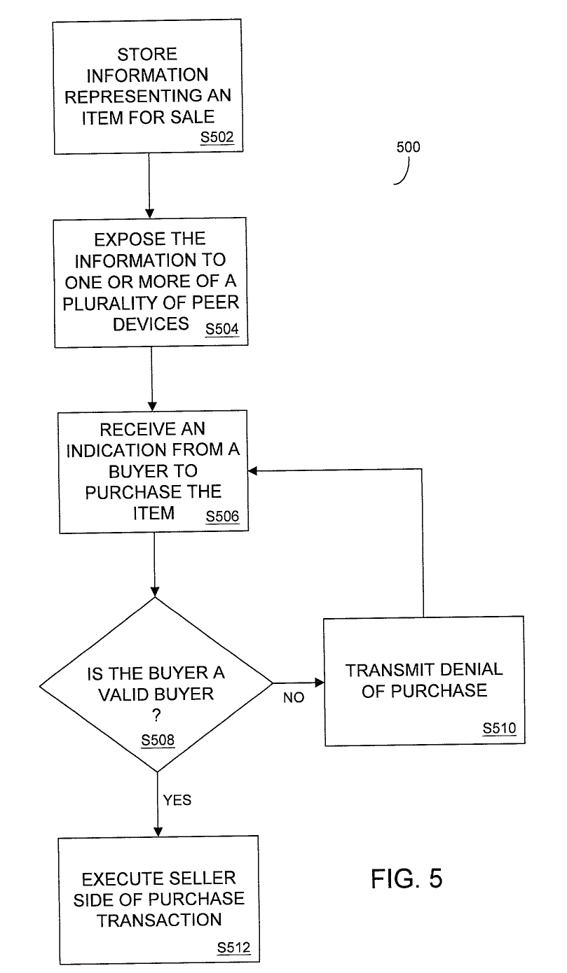

Process steps 500 of FIG. 5 set forth a process to sell an item according to embodiments of the present invention. Process steps 500 are described herein as being included in sale program 255 and executed by microprocessor 205 so as to be performed by peer device 200. Of course, it should be noted that process steps 500 may be performed by any device or number of devices, and that some of process steps 500 may be performed manually.

Briefly, according to process steps 500, information representing an item for sale is stored in a peer device of a peer-to-peer network comprising a plurality of peer devices, and the information is exposed to one or more of the plurality of peer devices. As described above, these steps allow a seller to easily offer an item for sale to many buyers over a robust network without incurring high overhead costs.

Flow begins at step S502, in which information representing an item for sale is stored. In one embodiment of step S502, the information includes a description, a condition, a sale price and valid buyer information, is input by an operator using input device 220, and is stored in sale item information database 300. As described above, the stored information representing an item may include other types of information.

The stored information need not be stored in a peer device operated by a seller of the item represented by the information. For example, the information may be stored on another peer device or a device outside the peer-to-peer network providing such storage. More specifically, information representing an item for sale may be stored in a device. Then, in step S502, a peer device may store a pointer to the information along with a sale price associated with the item. A seller may thereby offer an item for sale at a desired price without having to create and store the information representing the item. The resulting system offers improved competition because a seller may easily offer alternative prices, payment terms, or other features for an item offered by another seller by pointing to information representing the item that is stored by the other seller.

Alternatively, the information stored in step S502 may be alternative prices, payment terms, or other features stored by a peer device of a first seller on a second device operated by a second seller. In this regard, the second device stores information representing an item and the information stored in step S502 allows the first seller to offer sale terms different from those offered by the second seller. The second device may be a peer device or a device outside the peer-to-peer network. Accordingly, if the second device communicates its stored information representing an item to a buyer, the buyer is also presented with the alternative prices, payment terms, or other features stored in the second device by the peer device of the first seller.

In a more specific example of the foregoing, a second seller may store information in a website or in a peer-to-peer network representing a computer offered for $1000. In a case that a buyer accesses the information by accessing the website or through other means, the buyer will also be presented with an alternate offer for the same product, a similar product or a complementary product, the alternate offer being provided by a first seller. Such an alternative provides the first seller with a greater ability to compete with the second seller. Accordingly, potential buyers also benefit by gaining greater access to market information.

After step S502, the stored information is exposed to one or more of a plurality of peer devices in step S504. Depending upon the protocol of the peer-to-peer network, the information may be exposed by making the information available to inquiring peer devices, by transmitting the information to one or more peer devices, or by other known methods.

An indication to purchase the item is received from a buyer in step S506. For example, the indication may be received from a peer device over communication port 215 or through input device 220. The indication may include data identifying the buyer as well as the item.

After the indication is received, it is determined in step S508 whether the buyer is a valid buyer. In one embodiment of step S508, item ID 310 associated with the item is identified in database 300 and valid buyers 350 associated with item ID 310 are thereafter identified. Next, information associated with the buyer in buyer information database 400 is evaluated to determine whether the buyer meets the criteria set forth in associated valid buyer field 350. For example, in a case that an indication to purchase an item associated with item ID 310 “A30” is received from a buyer associated with buyer ID 410 “4T”, it is determined in step S508 that the buyer is not a valid buyer. This determination is due to the buyer's residence 430 of Minnesota, which is prohibited by valid buyers field 350 associated with item ID 310 “A30”. Similarly, a buyer associated with buyer ID 410 “396” would not be determined to be a valid buyer of the item because age 420 associated with the buyer does not meet the requirements of valid buyers field 350.

In other embodiments, the determination of step S508 proceeds by asking questions of the buyer, by receiving a password from the buyer verifying membership in one or more sets, by referring to data associated with the buyer in buyer information database 400, or by any other known method.

If it is determined in step S508 that the buyer is not a valid buyer, flow proceeds to step S510 wherein a denial of purchase is transmitted to the buyer. The denial of purchase may be a message informing the buyer that he is unable to purchase the item, and may include reasons as to why the purchase was denied. Flow then returns to step S506 and continues as described above.

If it is determined that the buyer is a valid buyer in step S508, the seller side of a purchase transaction is executed in step S512. The seller side of a purchase transaction includes those steps performed by a seller in executing a purchase transaction. For example, included in step S512 may be the steps of receiving buyer address information, receiving buyer credit card information, computing a total sale price including applicable taxes and shipping costs, obtaining authorization to charge the total sale price to the buyer's credit card, creating a confirmation number, and transmitting the confirmation number to the buyer.

In some embodiments, a third party performs step S512. The third party may be a payment clearinghouse designed to facilitate transactions between individuals. The clearinghouse may be provided with a payment equal to a fixed fee or based on the sale price of the item. The clearinghouse may also manage advertising on the peer-to-peer network in exchange for fees. In still other embodiments, a third party may provide micropayments to peer devices in exchange for services such as consummating commerce, transferring information, and providing information, or based on attributes such as individual ratings, quality of offered items and types of offered items.

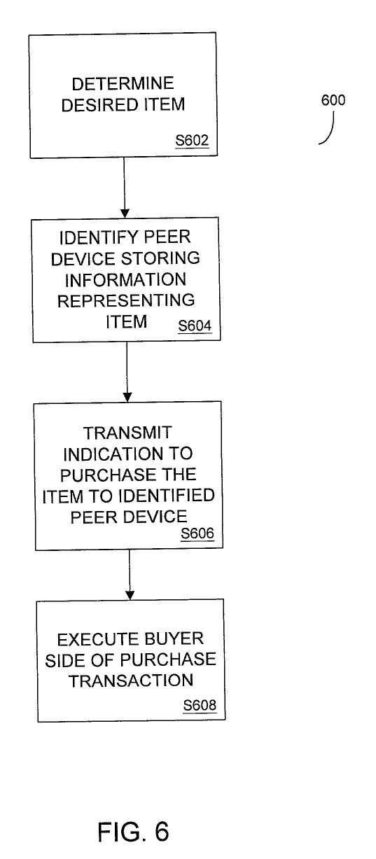

FIG. 6 illustrates process steps 600 to purchase an item according to one embodiment of the present invention. Although steps 600 are described below as being included in purchase program 260 and executed by microprocessor 205, steps 600 may be performed by any device or combination of devices.

Briefly, process steps 600 may be used to identify a peer device storing information representing a desired item from among a plurality of peer devices of a peer-to-peer network storing data representing one or more items for sale, and to transmit an indication to purchase the item. Again, the steps allow a buyer to use peer device 200 to locate a desired item and to purchase the item over a robust network.

In step S602, a desired item is determined. The item may be determined by receiving the name of the item from a buyer through input device 220. Alternatively, the buyer may be presented with a list of available items and a selection of one of the items may be received in step S602. The list may be based on desired item attributes input by the buyer. In yet another embodiment, no particular item is determined in step S602, rather, characteristics and/or attributes of a desired item are determined.

After the desired item is determined, a peer device storing information representing the item is determined in step S604. The peer device may be identified by querying each peer device in the peer-to-peer network as to whether it stores information representing the desired item. In a case that only desired characteristics and/or attributes are determined in step S602, peer devices storing information representing any item corresponding to the characteristics and/or attributes may be identified in step S604. The correspondence may be precise or based on fuzzy search algorithms. In other embodiments of steps S602 and S604, item orders are received from a buyer, the orders are compared to available items, and items deemed to match the orders are identified along with their corresponding peer devices.

Next, in step S606, an indication to purchase the item is transmitted to the identified peer device. As described with respect to process steps 500, the indication may include the buyer's identity, a buyer ID, a password, or other information using which the seller may determine if the buyer is a valid buyer of the item. Flow then proceeds to step S608 to execute buyer side steps of a purchase transaction. These steps may include transmission of address and credit card information to the identified peer device, and transmission of approval to charge a total sale price to the buyer's credit card.

Although the present invention has been described with respect to particular embodiments thereof, those skilled in the art will note that various substitutions may be made to those embodiments described herein without departing from the spirit and scope of the present invention.

What is claimed is:

1. A method to facilitate the purchase of items, comprising:
identifying a peer device storing information representing a desired item from among a plurality of peer devices of a peer-to-peer network storing data representing one or more items for sale; and
transmitting an indication to purchase the item.

2. A method according to claim 1, further comprising:
purchasing the item from the identified peer device.

3. A method according to claim 1, wherein each of the plurality of peer devices stores information representing distinct items.

4. A method according to claim 1, further comprising:
receiving a plurality of desired item attributes.

5. A method according to claim 4, further comprising:
transmitting the plurality of desired item attributes to a device; and
receiving information identifying the desired item from the device.

6. A method according to claim 4, further comprising:
determining the desired item based on the received plurality of desired item attributes.

7. A method to facilitate the sale of items, comprising:
storing information representing an item for sale in a peer device of a peer-to-peer network comprising a plurality of peer devices; and
exposing the information to one or more of the plurality of peer devices.

8. A method according to claim 7, wherein the information includes a sale price for the item.

9. A method according to claim 7, wherein the information includes a minimum bid price for the item.

10. A method according to claim 7, wherein the information specifies valid buyers of the item.

11. A method according to claim 10, wherein the valid buyers are members of one or more specified sets.

12. A method according to claim 11, wherein set membership is based on demographic parameters.

13. A method according to claim 11, wherein set membership is based on transaction histories.

14. A method according to claim 11, wherein the one or more specified sets include a set of which a seller of the item is a member.

15. A method according to claim 11, wherein a member of a set can vote to exclude a member from the set.

16. A method according to claim 11, wherein set membership is based upon payment.

17. A method according to claim 11, wherein set membership is based upon contribution to the network.

18. A method according to claim 11, wherein set membership is based upon usage of the network.

19. A method according to claim 11, wherein set membership is based on ratings.

20. A method according to claim 19, wherein the ratings are provided by a third party.

21. A method according to claim 19, wherein the ratings are based on transaction information.

22. A method according to claim 7, wherein the information includes a description of the item.

23. A method according to claim 7, wherein the information includes attributes of the item.

24. A method according to claim 7, wherein the information includes a password.

25. A method according to claim 7, further comprising:
receiving an inquiry from the one or more peer devices.

26. A method according to claim 25, further comprising:
determining if the one or more peer devices represent valid buyers of the item.

27. A method according to claim 7, wherein the information comprises a pointer to information representing the item stored in a second device and sale terms for the item that are different from sale terms for the item stored in the second device.

28. A method according to claim 7, wherein the information comprises a pointer to information representing the item stored in a second device and sale terms for a complementary item that is complementary to the item.

29. A method according to claim 7, wherein the information is stored in the peer device by a second device and the information comprises sale terms for the item that are different from sale terms for the item stored in the peer device.

30. A method according to claim 7, wherein the information is stored in the peer device by a second device and the information comprises sale terms for a complementary item that is complementary to the item.

31. An apparatus to facilitate the purchase of items, comprising:
a processor; and
a storage device in communication with said processor and storing instructions adapted to be executed by said processor to:
identify a peer device storing information representing a desired item from among a plurality of peer devices of a peer-to-peer network storing data representing one or more items for sale; and
transmit an indication to purchase the item.

32. An apparatus according to claim 31, wherein the stored instructions comprise instructions adapted to be executed by said processor to:
purchase the item from the identified peer device.

33. An apparatus according to claim 31, wherein each of the plurality of peer devices stores information representing distinct items.

34. An apparatus according to claim 31, wherein the stored instructions comprise instructions adapted to be executed by said processor to:
receive a plurality of desired item attributes.

35. An, apparatus according to claim 34, wherein the stored instructions comprise instructions adapted to be executed by said processor to:
transmit the plurality of desired item attributes to a device; and
receive information identifying the desired item from the device.

36. An apparatus according to claim 34, wherein the stored instructions comprise instructions adapted to be executed by said processor to:
determine the desired item based on the received plurality of desired item attributes.

37. An apparatus to facilitate the sale of items, comprising:
a processor; and
a storage device in communication with said processor and storing instructions adapted to be executed by said processor to:
store information representing an item for sale in a peer device of a peerto-peer network comprising a plurality of peer devices; and
expose the information to one or more of the plurality of peer devices.

38. An apparatus according to claim 37, wherein the information includes a sale price for the item.

39. An apparatus according to claim 37, wherein the information includes a minimum bid price for the item.

40. An apparatus according to claim 37, wherein the information specifies valid buyers of the item.

41. An apparatus according to claim 40, wherein the valid buyers are members of one or more specified sets.

42. An apparatus according to claim 41, wherein set membership is based on demographic parameters.

43. An apparatus according to claim 41, wherein set membership is based on transaction histories.

44. An apparatus according to claim 41, wherein the one or more specified sets include a set of which a seller of the item is a member.

45. An apparatus according to claim 41, wherein a member of a set can vote to exclude a member from the set.

46. An apparatus according to claim 41, wherein set membership is based upon payment.

47. An apparatus according to claim 41, wherein set membership is based upon contribution to the network.

48. An apparatus according to claim 41, wherein set membership is based upon usage of the network.

49. An apparatus according to claim 41, wherein set membership is based on ratings.

50. An apparatus according to claim 49, wherein the ratings are provided by a third party.

51. An apparatus according to claim 49, wherein the ratings are based on transaction information.

52. An apparatus according to claim 37, wherein the information includes a description of the item.

53. An apparatus according to claim 37, wherein the information includes attributes of the item.

54. An apparatus according to claim 37, wherein the information includes a password.

55. An apparatus according to claim 37, wherein the stored instructions comprise instructions adapted to be executed by said processor to:
receive an inquiry from the one or more peer devices.

56. An apparatus according to claim 55, wherein the stored instructions comprise instructions adapted to be executed by said processor to:
determine if the one or more peer devices represent valid buyers of the item.

57. An apparatus according to claim 37, wherein the information comprises a pointer to information representing the item stored in a second device and sale terms for the item that are different from sale terms for the item stored in the second device.

58. An apparatus according to claim 37, wherein the information comprises a pointer to information representing the item stored in a second device and sale terms for a complementary item that is complementary to the item.

59. An apparatus according to claim 37, wherein the information is stored in the peer device by a second device and the information comprises sale terms for the item that are different from sale terms for the item stored in the peer device.

60. An apparatus according to claim 37, wherein the information is stored in the peer device by a second device and the information comprises sale terms for a complementary item that is complementary to the item.

61. A medium storing processor-executable process steps, the process steps comprising:
a step to identify a peer device storing information representing a desired item from among a plurality of peer devices of a peer-to-peer network storing data representing one or more items for sale; and
a step to transmit an indication to purchase the item.

62. A medium according to claim 61, the process steps further comprising:
a step to purchase the item from the identified peer device.

63. A medium according to claim 61, wherein each of the plurality of peer devices stores information representing distinct items.

64. A medium according to claim 61, the process steps further comprising:
a step to receive a plurality of desired item attributes.

65. A medium according to claim 64, the process steps further comprising:
a step to transmit the plurality of desired item attributes to a device; and
a step to receive information identifying the desired item from the device.

66. A medium according to claim 64, the process steps further comprising:
a step to determine the desired item based on the received plurality of desired item attributes.

67. A medium storing processor-executable process steps, the process steps comprising:
a step to store information representing an item for sale in a peer device of a peer-to-peer network comprising a plurality of peer devices; and
a step to expose the information to one or more of the plurality of peer devices.

68. A medium according to claim 67, wherein the information includes a sale price for the item.

69. A medium according to claim 67, wherein the information includes a minimum bid price for the item.

70. A medium according to claim 67, wherein the information specifies valid buyers of the item.

71. A medium according to claim 70, wherein the valid buyers are members of one or more specified sets.

72. A medium according to claim 71, wherein set membership is based on demographic parameters.

73. A medium according to claim 71, wherein set membership is based on transaction histories.

74. A medium according to claim 71, wherein the one or more specified sets include a set of which a seller of the item is a member.

75. A medium according to claim 71, wherein a member of a set can vote to exclude a member from the set.

76. A medium according to claim 71, wherein set membership is based upon payment.

77. A medium according to claim 71, wherein set membership is based upon contribution to the network.

78. A medium according to claim 71, wherein set membership is based upon usage of the network.

79. A medium according to claim 71, wherein set membership is based on ratings.

80. A medium according to claim 79, wherein the ratings are provided by a third party.

81. A medium according to claim 79, wherein the ratings are based on transaction information.

82. A medium according to claim 67, wherein the information includes a description of the item.

83. A medium according to claim 67, wherein the information includes attributes of the item.

84. A medium according to claim 67, wherein the information includes a password.

85. A medium according to claim 67, the process steps further comprising:
a step to receive an inquiry from the one or more peer devices.

86. A medium according to claim 85, the process steps further comprising:
a step to determine if the one or more peer devices represent valid buyers of the item.

87. A medium according to claim 67, wherein the information comprises a pointer to information representing the item stored in a second device and sale terms for the item that are different from sale terms for the item stored in the second device.

88. A medium according to claim 67, wherein the information comprises a pointer to information representing the item stored in a second device and sale terms for a complementary item that is complementary to the item.

89. A medium according to claim 67, wherein the information is stored in the peer device by a second device and the information comprises sale terms for the item that are different from sale terms for the item stored in the peer device.

90. A medium according to claim 67, wherein the information is stored in the peer device by a second device and the information comprises sale terms for a complementary item that is complementary to the item.
